(19) United States
(12) Patent Application Publication
(10) Pub. No.: US 2024/0428086 A1
(43) Pub. Date: Dec. 26, 2024

(54) INCORPORATING APPROXIMATE NEAREST NEIGHBOR SEARCH AS IMPLICIT EDGE IN KNOWLEDGE GRAPH

(71) Applicant: Microsoft Technology Licensing, LLC, Redmond, WA (US)

(72) Inventors: Jan-Ove Almli KARLBERG, TromsØ (NO); Jeffrey L. Wight, Kirkland, WA (US); Tor Kreutzer, Harstad (NO); Øystein Fledsberg, Trondheim (NO); Ronny Jensen, TromsØ (NO); Anders Tungeland Gjerdrum, TromsØ (NO); Theodoros Gkountouvas, TromsØ (NO)

(21) Appl. No.: 18/213,138

(22) Filed: Jun. 22, 2023

(51) Int. Cl. G06N 5/02

(52) U.S. Cl. CPC G06N 5/02

(57) ABSTRACT

Systems and methods are directed to incorporating approximate nearest neighbor search as implicit edges in a knowledge graph. The system generates an approximate nearest neighbor (ANN) index that indexes entities by their embeddings. The system models a knowledge graph by including the embeddings as nodes in the knowledge graph. Based on a search query, the system performs a search of the knowledge graph to obtain results, whereby performing the search includes traversing one or more implicit edges from a node of an embedding in the knowledge graph to one or more related nodes in semantic vector space based on the ANN index. The results are then presented on the device of the user.

### TECHNICAL FIELD

The subject matter disclosed herein generally relates to execution of graph queries. Specifically, the present disclosure addresses systems and methods that incorporate approximate nearest neighbor search as implicit edges in a knowledge graph.

### BACKGROUND

Graph abstraction is a powerful tool that allows for reasoning over connected data. Knowledge graphs organize data from multiple sources and provides a collection of linked descriptions of entities represented as nodes and relationships/actions between the entities represented as edges. In the case of the enterprise knowledge graph, the knowledge graph ties together knowledge, resources, people, and the like within the enterprise. In some cases, the data comprising the enterprise knowledge graph originates from a plurality of heterogenous systems whereby each system may be built according to specific requirements of the data hosted therein. Conventionally, a query of the enterprise knowledge graph can require a long wait time because the query often involves calling to multiple user-centric services. For example, a query to find documents modified by a team is similar to calling a user's directs—a query that typically results in a fanout to N different user-centric services. This kind of calling pattern is problematic because it is necessary to wait for the slowest call.

### BRIEF DESCRIPTION OF THE DRAWINGS

Some embodiments are illustrated by way of example and not limitation in the figures of the accompanying drawings.

FIG. 1A illustrates an example of an enterprise knowledge graph.

FIG. 1B illustrates a sample mapping with implicit edges through semantic space.

FIG. 2 is a diagram illustrating a network environment suitable for incorporating approximate nearest neighbor search as implicit edges in a knowledge graph, in accordance with example embodiments.

FIG. 3 is a diagram illustrating components of a network system for incorporating approximate nearest neighbor search as implicit edges in a knowledge graph, according to some example embodiments.

FIG. 4 is a flowchart illustrating operations of a method for incorporating approximate nearest neighbor search as implicit edges in a knowledge graph, according to some example embodiments.

FIG. 5 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example embodiments are directed to efficiently and quickly performing a query on an enterprise knowledge graph by incorporating approximate nearest neighbor search as implicit edges in a knowledge graph. The enterprise knowledge graph is a collection of assets, content, and data that uses data models to describe people, places, and things and their relationships. The people, places, and things (collectively referred to as “entities”) make up the nodes of the enterprise knowledge graph while edges illustrates a relationship between two nodes.

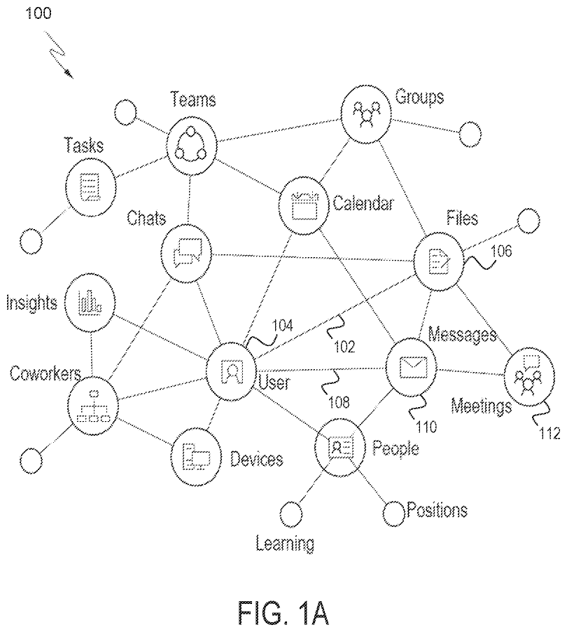

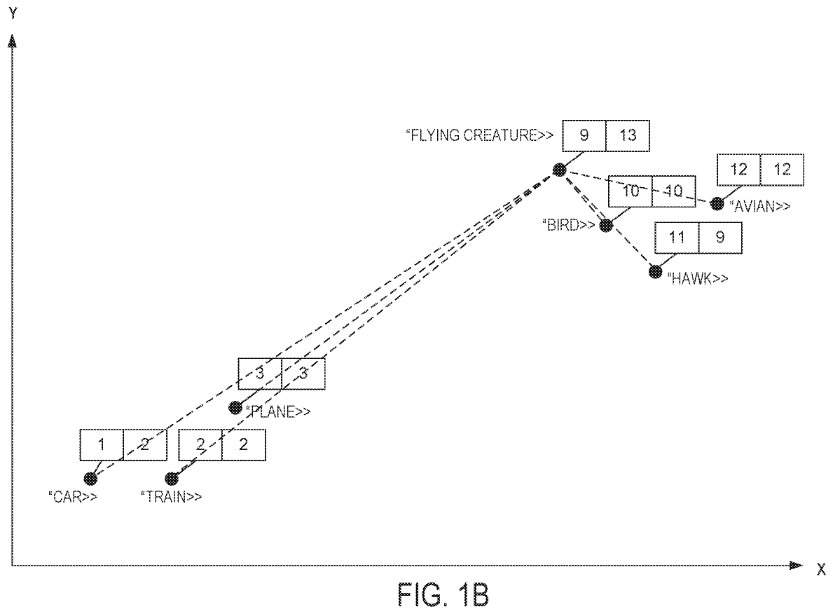

FIG. 1A illustrates an example of an enterprise knowledge graph 100. Here, the enterprise knowledge graph 100 illustrates nodes including, for example, tasks, chats, calendars, teams, devices, meeting, and other entities within the enterprise. Edges shown between the various nodes provide relationships between the nodes. For instance, a user may have created or modified various files, thus resulting in edge 102 between a user node 104 and a files node 106. Similarly, the user may have sent or received various messages (e.g., resulting in an edge 108 between the user node 104 and a message node 110) and these messages may indicate meetings (e.g., resulting in an edge between the message node 110 and a meetings node 112).

The various nodes may be associated with different data stores in the enterprise. Example embodiments provide systems and method that can efficiently access these data stores to construct the enterprise knowledge graph and subsequently perform a query for information. Recent advances in artificial intelligence (AI) and computing technology has made it possible to implement new and powerful techniques for effectively searching in high-dimensional vector spaces. For example, a semantic search can be conducted where a search query is mapped into a semantic vector space. The semantic vector space is a space where “meaning” is retained. Documents and other entities are also mapped into the same semantic space, whereby a vector is associated with each document or entity. This type of vector is referred to as an “embedding.”

Example embodiments bridge the gap between pre-existing technologies of approximate nearest neighbor (ANN) searches and explicit graph traversals by combining both in a single unified system. This is achieved by modeling ANN relationships as edges in the enterprise knowledge graph and embeddings as nodes. An Approximate Nearest Neighbor (ANN) index indexes documents by their embeddings. The ANN index then maps an input query to the same vector space as the embeddings therein and provides search results. The key insight is that in a vector space, everything is similar to everything else to some degree. As such, there exists a “Similar_To” edge between all items. In the example of semantic search, this allows queries such as, for example, “Can I bring my dog to work?” to return an intranet page “Pets Policy at CompanyX” as the top hit.

In one example, the enterprise knowledge graph stores data in separate heterogenous data stores. At a high level, nodes, edges, and properties thereon are mapped from underlying data stores providing the data into a graph schema. At query time, graph queries spanning these stores are parsed and compiled into programs where different parts execute in/towards the stores that must be involved. The edges in the enterprise knowledge graph are explicit. For example, they may indicate that a user has modified a document or that a user has commented on another user's document.

By incorporating ANN indexes, as well as applying careful data modeling, expressive graph queries can be executed that leverage the power of the ANN indexes. With ANNs, there are no explicit edges in the enterprise knowledge graph. Instead, there is just a distance in semantic space between vectors. In executing a query, the system anchors in an explicit node given by, for example, an identifier, and “walks” the explicit edges to documents that have been modified. The system then takes a leap through the semantic vector space to find other items that are similar to those documents, for instance, from which the system continues the explicit “walk.”

One example query (“Example Query 1”) supported by such a system is the following:
MATCH (user)-[:HAS_EMBEDDING]->(embedding)-[ann:SIMILAR_TO]->(related)
WHERE user.ObjectId=$myId
RETURN related.Title
   The above query finds all documents deemed to be similar to a user and returns their titles. In particular, a user has an embedding and that embedding can be used with ANN to find other things that are similar in that vector space and that is modeled through an edge—[ann:SIMILAR_TO]->. This edge appears like any other edge, but it is not explicit. It is formed based on distance functions in the vector space.

As an example, and referring to FIG. 1B, an illustration of a two-dimensional mapping with implicit edges through semantic space is shown. The corresponding query may be
MATCH (embedding)-[ann:SIMILAR_TO]->(related)
WHERE embedding.Vector=fromQueryString(‘Flying Creature’)
RETURN related.Title

Here, the input vector in text form is “flying creature.” This input vector is mapped into a two-dimensional (2-D) point of x=9, y=13. Relatively close to this embedding vector in the semantic space are the concepts of “bird” (x=10, y=10), “avian” (x=12, y=12), and “hawk” (x=11, y=9). A bit further away are “plane” and more remote concepts of “car” and “train.” The dashed lines indicate that there exists implicit edges between all of these vectors—but their closeness/distance differ. That is, implicit edges can be created between any two nodes that are close in the vector space and can be ordered on the distance. As such, the system can “jump” in vector space from the input vector via the implicit edges to the various concepts.

Thus, the enterprise knowledge graph spans both implicit and explicit edges and a user of the system does not need to understand whether or not an edge is implicit or explicit. Additionally, the system can take jumps through vector spaces. As such, the system can do part of the graph traversal in explicit real space and then take a jump through the vector space and come out in an explicit node and continue the traversal. There can be any number of such vector spaces.

As a result, example embodiments provide a technical solution to the technical problem of performing efficient searching of an enterprise knowledge graph. Example embodiments solve this problem by extending graph query language and runtime to enable and incorporate approximate nearest neighbor (ANN) search that represents edges in an enterprise knowledge graph. This is possible by incorporating ANN indexes into a “plugin model” and processing graph queries using the model. Example embodiments also include access control when a user embedding is private to the user or based on access control policies.

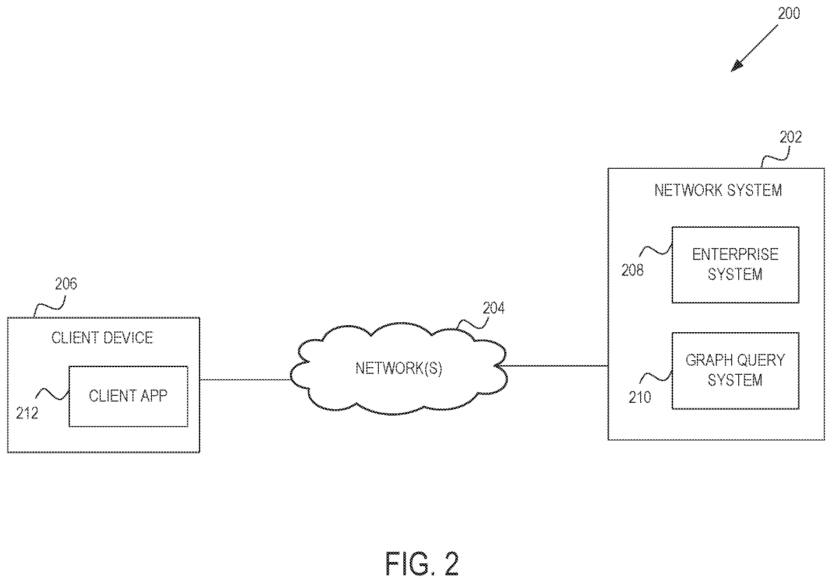

FIG. 2 is a diagram illustrating a network environment 200 suitable for incorporating approximate nearest neighbor (ANN) search as implicit edges in an enterprise knowledge graph, in accordance with example embodiments. A network system 202 is communicatively coupled, via a network 204, to a client device 206. In some embodiments, the network system 202 is associated with a single entity and comprises an enterprise system 208 and a graph query system 210. In alternative embodiments, the graph query system 210 may be located separate from the network system 202 that includes the enterprise system 208, whereby the graph query system 210 is communicatively coupled to the enterprise system 208.

The enterprise system 208 is configured to track and control operations of an enterprise or organization associated with the network system 202. In some cases, the enterprise system 208 includes a cloud-based software-as-a-service (SaaS) system that provides a plurality of applications, protocols, and functionalities to the enterprise that allow the enterprise to integrate business processes and share information across business functions and employee hierarchies. For instance, there may be a first service hosting contacts, a second service hosting profiles for people, a third service hosting documents and connections between people and documents, and so forth. In example embodiments, the network system 202 is configured to generate an enterprise knowledge graph for the enterprise system 208 that ties all these isolated services together to form a logical graph. Such an enterprise knowledge graph can be traversed for data in the enterprise by the graph query system 210.

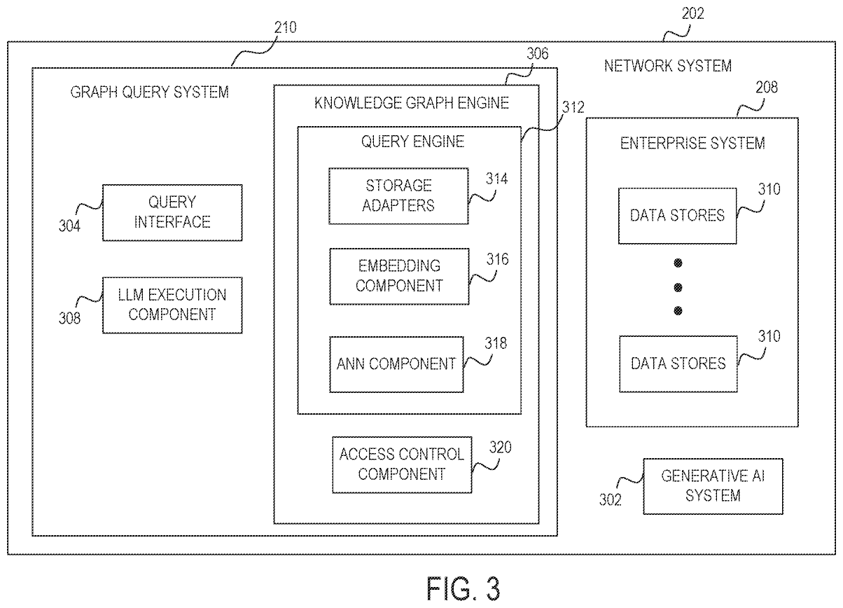

The graph query system 210 is a component of the network system 202 that performs graph query evaluations of the enterprise knowledge graph. Example embodiments use the graph query system 210 to perform a knowledge graph traversal of an enterprise knowledge graph to obtain a query result. The graph query system 210 will be discussed in more detail in connection with FIG. 3 below.

The client device 206 is a device of a user of the network system 202. In some cases, the user has an enterprise-related question they want answered by the network system 202. For instance, the user wants to know if they can bring their dog to work. In some cases, the user can type this question into an interface at the client device 206. The network system 202, in background, receives this question and makes an application programming interface (API) call to a large language model (LLM) or artificial intelligence system that generates a graph query in a graph query language (e.g., in Cypher language). The LLM may be a part of the network system 202 or be external but communicative coupled to the network system 202. In other cases, the user can input the graph query in the appropriate graph query language that indicates the question they want answered.

The client device 206 may comprise, but is not limited to, a smartphone, tablet, laptop, multi-processor systems, microprocessor-based or programmable consumer electronics, game consoles, a server, or any other communication device that can perform operations with respect to the network system 202 via the network 204. In example embodiments, the client device 206 comprises one or more client applications 212 that communicate with the network system 202 for added functionality. For example, the client application 212 may be a local version of an application or component of the network system 202. Alternatively, the client application 212 exchanges data with one or more corresponding components/applications at the network system 202. For instance, the client application 212 can be a mobile productivity application (e.g., Microsoft 365 application) and the corresponding application at the network system 202 is Microsoft 365. The client application 212 may be provided by the network system 202 and/or downloaded to the client device 206.

Depending on the form of the client device 206, any of a variety of types of connections and networks 204 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology. Enhanced Data rates for GSM Evolution (EDGE) technology, or other data transfer technology (e.g., 4G networks, 5G networks). When such technology is employed, the network 204 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks).

In another example, the connection to the network 204 is a Wireless Fidelity (Wi-Fi. IEEE 802.11x type) connection, a Worldwide Interoperability for Microwave Access (WiMAX) connection, or another type of wireless data connection. In some embodiments, the network 204 includes one or more wireless access points coupled to a local area network (LAN), a wide area network (WAN), the Internet, or another packet-switched data network. Accordingly, a variety of different configurations are expressly contemplated.

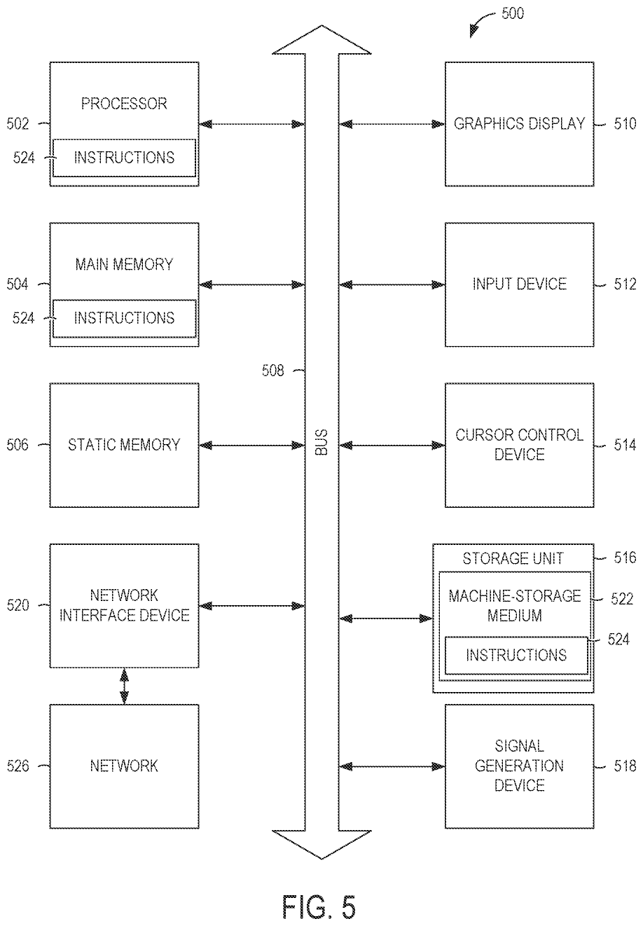

In example embodiments, any of the systems, devices, or networks (collectively referred to as “components”) shown in, or associated with, FIG. 2 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system, device, or machine. For example, a special-purpose computer system able to implement any one or more of the methodologies described herein is discussed below with respect to FIG. 5, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any of the components illustrated in FIG. 2 or their functions may be combined, or the functions described herein for any single component may be subdivided among multiple components. Additionally, any number of client devices 206 may be embodied within the network environment 200. While only a single network system 202 is shown, alternative embodiments contemplate having more than one network system 202 (e.g., each localized to a particular region) to perform the operations discussed herein.

FIG. 3 is a diagram illustrating components of the network system 202 for incorporating approximate nearest neighbor search as implicit edges in an enterprise knowledge graph, according to some example embodiments. To enable these operations, the network system 202 comprises the enterprise system 208, the graph query system 210 and, in some embodiments, an internal generative AI system 302 (also referred to herein for simplicity as a large language model or LLM), all communicatively couple to each other.

The graph query system 210 performs graph query evaluations of an enterprise knowledge graph (e.g., of the enterprise system 108) by generating and traversing an enterprise knowledge graph to obtain a result in response to a graph query. In one embodiment, the graph query system 210 comprises a query interface 304, a knowledge graph engine 306, and a LLM execution component 308.

The query interface 304 is configured to manage receipt and processing of a question or query by exchanging data with various components of the networking environment 200. Accordingly, the query interface 304 receives a question to be answered which may be in a natural language format or presented in a graph query language. In the case of a natural language question, the query interface 304 passes the question to the LLM execution component 308 which makes an application program interface (API) call to a LLM (e.g., an external generative AI system or the internal generative AI system 302) to generate a graph query in a native graph query language (e.g., Cypher). If the question is already presented in standard graph query language, the query interface 304 works with the other components of the graph query system 210 to process the graph query.

The knowledge graph engine 306 is configured to evaluate the graph query over the distributed enterprise system 208 to obtain a result to the query. In some embodiments, the knowledge graph engine 306 performs a federated search to search multiple data sources (e.g., data stores 310 of the enterprise system 208). Data sources includes databases, key-value stores, application programming interfaces (APIs) that pull data from other sources, and other data sources that are collectively referred to herein as data stores. A query planning schema is leveraged to enable the knowledge graph engine 306 to treat disparate data stores 310, which have potentially differing search capabilities, differing data content, differing latencies, differing physical characteristics (e.g., power sources), and other differences, as a single graph. The actual query execution may be centralized, distributed, or a combination of both.

Upon receipt of the graph query, a query engine 312 manages the generation and traversal of the enterprise knowledge graph. In one embodiment, the query engine 312 parses the graph query and compiles it into individual operations to be executed in order to satisfy the graph query. The operations are mapped to different underlying data stores 310 of the enterprise system 208.

The data stores 310 may be accessed and data analyzed through corresponding storage adapters or interfaces of the query engine 312. As such, the query engine 312 comprises a plurality of storage adapters (or interfaces) 314 that access data stores 310. For example, the plurality of storage adapters 314 can include a first storage adapter to access a message data store, a second storage adapter to access files, a third storage adapter to access user profiles, and so forth.

The query engine 312 also includes an embedding component 316. The embedding component 316 generates and manages embeddings. In some cases, the embeddings can be generated on-the-fly (e.g., during the execution of the search query) and is only valid during the execution of a corresponding search query. In these cases, the embedding component 316 accesses some data (e.g., text) and maps that data into an embedding. In other cases, the embedding component 316 identifies and uses existing embeddings. The embeddings are modeled as nodes in the enterprise knowledge graph. This graph modeling is important since it is possible for an entity to have multiple embeddings in different vector spaces and it is also possible, in some cases, to generate these embedding nodes on the fly.

A graph query may be written as, for example:
MATCH (embedding)-[ann:SIMILAR_TO]->(related)
WHERE embedding.Vector=fromQueryString(‘Search Text’)
RETURN related.Title

Here, the query engine 312 is matching on an embedding and follows an implicit edge from the embedding to something that is related or close to it in the semantic/vector space. In the next clause, the embedding component 316 is generating (or accessing) the embedding from an input string. In this case, the embedding is generated at runtime (on-the-fly) and is only valid for the execution of the query. The embedding is not attached to any other entity in the enterprise knowledge graph. This graph query differs from the above Example Query 1 where the query engine 312 anchors in a user that is identified by some identifier for which there exists an embedding from before.

Thus, example embodiments support both using existing embeddings and generating embeddings on-the-fly by modeling embeddings as nodes. Thus, an embedding is connected to a user through an edge, which makes it possible to change the above graph query slightly. For example, instead of having it from a query string, it can be from a user profile or some other input used to generate an embedding that represents something. These embeddings can be used to calculate distances between those things that you have been able to connect and use those distances for ranking purposes, for instance.

Additionally, the query engine 312 comprises an ANN component 318. The ANN component 318 is configured to manage the generation and updating of the ANN indexes, access to the ANN indexes, and the traversal of implicit edges in the enterprise knowledge graph. ANN techniques speed up searches by preprocessing data into an efficient index. The index can be stored or used immediately, and searches can be interleaved. In one instance, the indexes can be generated by a batch update. Here, the index is built and then automatically enabled for all items. In another instance, the index can be incrementally updated in which new items are added to the index as they are created and pre-existing items are updated as they are changed.

The enterprise knowledge graph is accessed and queried in a wealth of different ways. In some cases, a query is executed in the context of a single user and can be effectively served from a single user-centric service. Here, all data that is relevant can be stored locally with the user. For instance, a user wants to capture all of the items that the user has interacted with in the past month. Given just the single user, the query system 210 can satisfy that query on a single server effectively and the ANN index can be over that subset of data in the single server. Then, a semantic search can be performed over all the data that the user interacted with effectively on a single server.

In other cases, the query execution must consider embeddings of multiple users. For example, a sample graph query may be:
MATCH (me)-[:MANAGER_OF]->(dir)-[:HAS_EMBEDDING]->(emb)-[:SIMILAR_TO]->(related)
WHERE user.ObjectId=$myId
RETURN related.Title

In this query, the goal is to find documents that are similar to the calling users directs—a query that typically would result in a fanout to N different user centric services. This kind of calling pattern is problematic because it is necessary to wait for the slowest call.

Example embodiments account for these patterns and selectively place data according to scenario needs. User embeddings, for example, are placed both in a user-centric system that allows efficient access and usage when only a single user is involved, but also in a tenant-wide system that allows efficient retrieval and execution in the case of the above query. Thus, instead of duplicating all that data out to all of the different servers running for each user, a centralize store and a centralized ANN index (or global ANN index) is used.

When executing a query, both local and global indexes can be used, and they are compatible given that the vector spaces are the same. This is what is occurring in the above query. The graph query system 210 anchors in the user, finds all of the user's directs (all the people that report to the user), and finds all of their embeddings. This can occur by either going out to all the directs (e.g., going out to all the different servers of the directs to retrieve corresponding embeddings) or the embedding can be stored in a single spot (e.g., centralized store) and be retrieved more effectively.

By trading extra overhead in storage, example embodiments can thus cater to scenarios with widely different needs. This provides low latency and efficient query execution. It should be noted that exactly where the data is hosted and how it is stored is completely hidden from a query writer—the graph execution framework makes the determination of how to fetch data and which data stores to involve as part of the query planning process.

Nodes and edges in the enterprise knowledge graph are subject to access controls (e.g., a document that is visible to user A is not necessarily visible to user B). These access controls must be respected in the case of ANN-based graph traversals. In example embodiments, an access control component 320 manages the access control. The access control component 320 identifies a user associated with the question or query and determines rights associated with the user. The access control component 320 also determines access control policies associated with candidate items being accessed. The access control rights and policies are then compared. In one embodiment, the access control policies and rights are provided to the query engine 312 and utilized while traversing the enterprise knowledge graph. In other embodiments, the results obtained by the query engine 312 are filtered by the access control component 320 or by another service.

In the above examples, only those documents that are accessible by a calling user should be returned. Not all ANN components of the enterprise knowledge graph are capable of evaluating access control internally (e.g., results from invoking an ANN index is a set of non-trimmed results). The ANN index is good at taking an input vector and locating other input vectors that are similar—calculating the distance. That only helps locate candidates. In these cases, the graph query execution framework (the access control component 320) can place access control checks for these candidates in-line as part of the graph query execution. These access control checks can take the form of a subsequent API call to a service capable of evaluating whether the candidate item is accessible to the user.

Whether an embedding is accessible to a calling user depends on multiple things. The simplest example is a transitive one: an embedding, E_{D}, for document D is only accessible to user A if D is accessible to A. Likewise, for a tenant-wide embedding. TEA, for user B, is only accessible to user A if B is accessible to A.

A user embedding is deemed private to the user if it can be used to infer private information about the user. An example would be an embedding generated out of the user's access to documents. Then, the embedding can ultimately be used to reason about which documents the user has read, which may or may not be private. For private embeddings, access is limited to only an owning user and certain vetted scenarios and/or services where it is known this information will not be abused.

Because of how and from which data embeddings are derived, some embeddings are private to a given user when consumed in raw form. For example, a personalized embedding for user A. EP_{A}, should only be accessible to user A, and not to user B, regardless of whether or not user B has access to the user node for A. There are, however, cases where such personalized/private embeddings can be leveraged by specific applications that leverage these to construct a user experience but does so in a privacy preserving way. Such cases of differential privacy/access control are supported by leveraging scopes in tokens (e.g., only those applications which should be granted access to this kind of private data will have a “read private embedding scope” in their token thus, unlocking this ability).

Returning to the above graph query involving embeddings of multiple users,
MATCH (me)-[:MANAGER_OF]->(dir)-[:HAS_EMBEDDING]->(emb)-[:SIMILAR_TO]->(related)
WHERE user.ObjectId=$myId
RETURN related.Title

Following the graph traversal, the knowledge graph engine 306 starts with an embedding associated with the user (e.g., (me)-[:MANAGER_OF]->(dir)-[:HAS_EMBEDDING]->(emb)) and uses implicit edges to find related things (e.g., —[:SIMILAR_TO]->(related)). These are things that are similar to the direct, and thus similar to the user, which can be documents. There is nothing in this graph query indicating that access control is needed. The knowledge graph engine 306 executes the ANN search to find these candidates (e.g., documents of things that are similar). Then after finding those candidates, the access control component 320 explicitly checks whether or not they can be returned to the calling user (e.g., whether the calling user has access). To do this efficiently, the access control component 320 can, in some cases, query (e.g., make an API call) some other system that is capable of evaluating whether the user has access or not. Access control information is received from the further system. Based on the access control information, results can be filtered out that a user does not have access to.

In an alternative embodiment, access control can be built into the ANN index. In these cases, the ANN index is accessed, whereby the ANN index includes access control information. Based on the access control information, a determination is made whether the user has access to the documents in a result set. Results that the user does not have access to can then be filtered out.

In some cases, the access control component 320 inspects the graph query and determines whether or not the ANN index can execute access control on its own. If the ANN index can execute access control, then the access control component 320 does not need to perform any further operations. If the ANN index cannot execute access control, the access control component 320 can either make a sequent API call to a different system that can perform access control or the access control component 320 can inspect a query plan and determine whether the traversal will retrieve data from a system that can perform access control. If traversal will retrieve data from a system that can perform access control, the two operations (access control and data retrieval) can be combined. This optimizes the query execution to remove any unnecessary API calls to perform access control.

While the graph query system 210 is shown as part of the network system 202, alternative embodiments may contemplate have some or all of the operations occurring at the client device 206. For example, some of the components of the graph query system 210 can be embodied in the client application 212 operating on the client device 206.

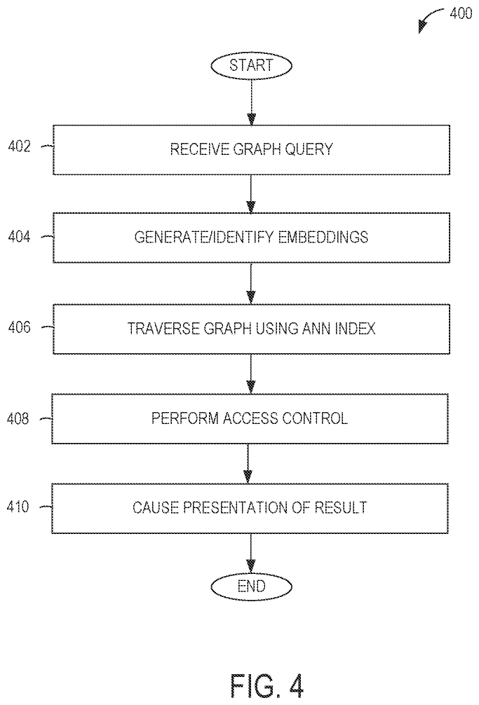

FIG. 4 is a flowchart illustrating operations, performed by the network system 202, of a method 400 for incorporating approximate nearest neighbor search as implicit edges in an enterprise knowledge graph, according to some example embodiments. Operations in the method 400 may be performed by the network system 202 in the network environment 200 described above with respect to FIG. 2 and FIG. 3. Accordingly, the method 400 is described by way of example with reference to these components in the network system 202. However, it shall be appreciated that at least some of the operations of the method 400 may be deployed on various other hardware configurations or be performed by similar components residing elsewhere in the network environment 200. Therefore, the method 400 is not intended to be limited to these components.

At various times, the ANN component 318 generates and/or updates the ANN index. The index can be stored in a data store or be used immediately. The ANN component 318 provides access to previously generated ANN indexes during runtime.

In operation 402, the knowledge graph engine 306 receives a graph query. Upon receipt of the graph query, the query engine 312 manages the traversal of the enterprise knowledge graph. In one embodiment, the query engine 312 parses the graph query and compiles it into individual operations to be executed in order to satisfy the graph query, whereby the operations are mapped to different underlying data stores 214 of the enterprise system 108. The data stores 214 are accessed through corresponding storage adapters or interfaces associated with the query API component 212.

In operation 404, one or more embeddings are identified and/or generated by the embedding component 316. In some cases, the embedding component 316 identifies and uses existing embeddings that are nodes in the enterprise knowledge graph. In other cases, the embeddings are generated on-the-fly and are relevant only for the specific query execution. In these cases, the embedding component 316 accesses data associated with one or more entities and maps that data into one or more embeddings. The generated embeddings are then modeled as nodes in the enterprise knowledge graph for the duration and within the context of the specific query execution.

In operation 406, the knowledge graph engine 306 traverses the enterprise knowledge graph to obtain a result based on the graph query. The traversal is performed using the corresponding ANN index. Traversing the enterprise knowledge graph includes traversing explicit edges and implicit edges. The ANN component 318 is configured to manage the traversal of implicit edges in the enterprise knowledge graph. For example, the ANN component 318 matches an embedding based on the query (e.g., an anchor embedding/node) and follows an implicit edge from a node corresponding to the embedding to a related node (e.g., another embedding or something that is related or close to it) in the semantic/vector space based on the ANN index. In some cases, the various nodes can be ranked based on distances in the semantic space. Thus, for example, a node that has the smallest distance may be returned as an answer to the query.

In operation 408, access control is performed. In example embodiments, an access control component 320 manages the access control. The access control component 320 identifies a user associated with the question or query and determines access control rights associated with the user. The access control component 320 also identifies access control policies associated with candidate items with which access is being checked. The access control policies are then compared to the access control rights. In one embodiment, the access control policies and rights are provided to the query engine 312 and utilized while traversing the enterprise knowledge graph. In other embodiments, the results obtained by the query engine 312 are filtered by the access control component 320 or by another service via an API call.

In operation 410, the result is presented on a client device. In some embodiments, the result is presented on a user interface through which a user presented the question to be answered or a command to be performed. Alternatively, the result can be presented in response to a chat input. In these cases, the result can be provided in a chat window (e.g., a chat window through which the query/question was input), or the result can be presented in a format that can be incorporated into a document being edited through the productivity application. For example, the result can be presented inline in a document being edited using the productivity application but visually distinguished (e.g., in a different text color, highlighted).

While examples discussed herein are directed to generating and searching enterprise knowledge graphs, concepts described herein are applicable to any type of knowledge graph. Therefore, example embodiments are not limited to searching enterprise knowledge graphs or data associated with an enterprise.

FIG. 5 illustrates components of a machine 500, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 5 shows a diagrammatic representation of the machine 500 in the example form of a computer device (e.g., a computer) and within which instructions 524 (e.g., software, a program, an application, an applet, an app, or other executable code) for causing the machine 500 to perform any one or more of the methodologies discussed herein may be executed, in whole or in part.

For example, the instructions 524 may cause the machine 500 to execute the flow diagram of FIG. 4. In one embodiment, the instructions 524 can transform the machine 500 into a particular machine (e.g., specially configured machine) programmed to carry out the described and illustrated functions in the manner described.

In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524 (sequentially or otherwise) that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, or a cathode ray tube (CRT), or any other display capable of displaying graphics or video). The machine 500 may also include an input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a sound card, an amplifier, a speaker, a headphone jack, or any suitable combination thereof), and a network interface device 520.

The storage unit 516 includes a machine-storage medium 522 (e.g., a tangible machine-storage medium) on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered as machine-storage media (e.g., tangible and non-transitory machine-storage media). The instructions 524 may be transmitted or received over a network 526 via the network interface device 520.

In some example embodiments, the machine 500 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 504, 506, and/or memory of the processor(s) 502) and/or storage unit 516 may store one or more sets of instructions and data structures (e.g., software) 524 embodying or utilized by any one or more of the methodologies or functions described herein. These instructions, when executed by processor(s) 502 cause various operations to implement the disclosed embodiments.

As used herein, the terms “machine-storage medium,” “device-storage medium,” “computer-storage medium” (referred to collectively as “machine-storage medium 522”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 522 include non-volatile memory, including by way of example semiconductor memory devices, for example, erasable programmable read-only memory (EPROM), electrically erasable programmable read-only memory (EEPROM). FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 522 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 524 may further be transmitted or received over a communications network 526 using a transmission medium via the network interface device 520 and utilizing any one of a number of well-known transfer protocols (e.g., HTTP). Examples of communication networks 526 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 524 for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### Examples

Example 1 is a method for incorporating approximate nearest neighbor search as implicit edges in a knowledge graph. The method comprises accessing an approximate nearest neighbor (ANN) index that indexes entities by their embeddings; modeling a knowledge graph by including the embeddings as nodes in the knowledge graph: receiving a search query from a device of a user; based on the search query, performing a search of the knowledge graph to obtain results, the performing the search including traversing one or more implicit edges from a node of an embedding in the knowledge graph to one or more related nodes in semantic vector space based on the ANN index; and causing presentation of the results on the device of the user.

In example 2, the subject matter of example 1 can optionally include generating the embedding during execution of the search query, the embedding being valid only during the execution of the search query.

In example 3, the subject matter of any of examples 1-2 can optionally include performing access control on the results, wherein only candidates of the results that are accessible by the user are returned.

In example 4, the subject matter of any of examples 1-3 can optionally include wherein performing access control comprises accessing the ANN index, the ANN index including access control information; determining from the ANN index whether the user has access to the candidates in the results; and filtering out candidates that the user does not have access to.

In example 5, the subject matter of any of examples 1-4 can optionally include wherein performing access control comprises calling a further service that includes access control information; receiving the access control information from the further system; and based on the access control information, filtering out candidates that the user does not have access to.

In example 6, the subject matter of any of examples 1-5 can optionally include wherein performing the search comprises performing the search on a single user-centric system for a single-user query.

In example 7, the subject matter of any of examples 1-6 can optionally include wherein performing the search comprises performing the search on a tenant-wide system for a multi-user query.

In example 8, the subject matter of any of examples 1-7 can optionally include wherein the ANN index comprises a local ANN index that is used to retrieve the results from a local server and a global ANN index that is used to retrieve the results from a plurality of servers, the global ANN index having a same vector space as the local ANN index.

In example 9, the subject matter of any of examples 1-8 can optionally include calculating distances between nodes of embeddings connected through implicit edges; ranking the nodes based on respective distances; and determining the results based on the ranking.

Example 10 is a system for incorporating approximate nearest neighbor search as implicit edges in a knowledge graph. The system comprises one or more processors and a memory storing instructions that, when executed by the one or more processors, cause the one or more processors to perform operations comprising accessing an approximate nearest neighbor (ANN) index that indexes entities by their embeddings; modeling a knowledge graph by including the embeddings as nodes in the knowledge graph; receiving a search query from a device of a user; based on the search query, performing a search of the knowledge graph to obtain results, the performing the search including traversing one or more implicit edges from a node of an embedding in the knowledge graph to one or more related nodes in semantic vector space based on the ANN index; and causing presentation of the results on the device of the user.

In example 11, the subject matter of example 10 can optionally include wherein the operations further comprise generating the embedding during execution of the search query, the embedding being valid only during the execution of the search query.

In example 12, the subject matter of any of examples 10-11 can optionally include wherein the operations further comprise performing access control on the results, wherein only candidates of the results that are accessible by the user are returned.

In example 13, the subject matter of any of examples 10-12 can optionally include wherein performing access control comprises accessing the ANN index, the ANN index including access control information; determining from the ANN index whether the user has access to the candidates in the results; and filtering out candidates that the user does not have access to.

In example 14, the subject matter of any of examples 10-13 can optionally include wherein performing access control comprises calling a further service that includes access control information; receiving the access control information from the further system; and based on the access control information, filtering out candidates that the user does not have access to.

In example 15, the subject matter of any of examples 10-14 can optionally include wherein performing access control comprises calling a further service that includes access control information; receiving the access control information from the further system; and based on the access control information, filtering out candidates that the user does not have access to.

In example 16, the subject matter of any of examples 10-15 can optionally include wherein performing the search comprises performing the search on a tenant-wide system for a multi-user query.

In example 17, the subject matter of any of examples 10-16 can optionally include wherein the ANN index comprises a local ANN index that is used to retrieve the results from a local server and a global ANN index that is used to retrieve the results from a plurality of servers, the global ANN index having a same vector space as the local ANN index.

In example 18, the subject matter of any of examples 10-17 can optionally include wherein the operations further comprise calculating distances between nodes of embeddings connected through implicit edges; ranking the nodes based on respective distances; and determining the results based on the ranking.

Example 19 is a storage medium comprising instructions which, when executed by one or more processors of a machine, cause the machine to perform operations for incorporating approximate nearest neighbor search as implicit edges in a knowledge graph. The operations comprise accessing an approximate nearest neighbor (ANN) index that indexes entities by their embeddings; modeling a knowledge graph by including the embeddings as nodes in the knowledge graph; receiving a search query from a device of a user; based on the search query, performing a search of the knowledge graph to obtain results, the performing the search including traversing one or more implicit edges from a node of an embedding in the knowledge graph to one or more related nodes in semantic vector space based on the ANN index; and causing presentation of the results on the device of the user.

In example 20, the subject matter of example 19 can optionally include wherein the operations further comprise generating the embedding during execution of the search query, the embedding being valid only during the execution of the search query.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising,
accessing an approximate nearest neighbor (ANN) index that indexes entities by their embeddings;
modeling a knowledge graph by including the embeddings as nodes in the knowledge graph;
receiving a search query from a device of a user;
based on the search query, performing a search of the knowledge graph to obtain results, the performing the search including traversing one or more implicit edges from a node of an embedding in the knowledge graph to one or more related nodes in semantic vector space based on the ANN index; and
causing presentation of the results on the device of the user.

2. The method of claim 1, further comprising:
generating the embedding during execution of the search query, the embedding being valid only during the execution of the search query.

3. The method of claim 1, further comprising:
performing access control on the results, wherein only candidates of the results that are accessible by the user are returned.

4. The method of claim 3, wherein performing access control comprises:
accessing the ANN index, the ANN index including access control information;
determining from the ANN index whether the user has access to the candidates in the results; and
filtering out candidates that the user does not have access to.

5. The method of claim 3, wherein performing access control comprises:
calling a further service that includes access control information;
receiving the access control information from the further system; and
based on the access control information, filtering out candidates that the user does not have access to.

6. The method of claim 1, wherein performing the search comprises performing the search on a single user-centric system for a single-user query.

7. The method of claim 1, wherein performing the search comprises performing the search on a tenant-ide system for a multi-user query.

8. The method of claim 1, wherein the ANN index comprises a local ANN index that is used to retrieve the results from a local server and a global ANN index that is used to retrieve the results from a plurality of servers, the global ANN index having a same vector space as the local ANN index.

9. The method of claim 1, further comprising:
calculating distances between nodes of embeddings connected through implicit edges;
ranking the nodes based on respective distances; and
determining the results based on the ranking.

10. A system comprising,
one or more processors; and
a memory storing instructions that, when executed by the one or more processors, cause the one or more processors to perform operations comprising:
accessing an approximate nearest neighbor (ANN) index that indexes entities by their embeddings;
modeling a knowledge graph by including the embeddings as nodes in the knowledge graph;
receiving a search query from a device of a user;
based on the search query, performing a search of the knowledge graph to obtain results, the performing the search including traversing one or more implicit edges from a node of an embedding in the knowledge graph to one or more related nodes in semantic vector space based on the ANN index; and
causing presentation of the results on the device of the user.

11. The system of claim 10, wherein the operations further comprise:
generating the embedding during execution of the search query, the embedding being valid only during the execution of the search query.

12. The system of claim 10, wherein the operations further comprise:
performing access control on the results, wherein only candidates of the results that are accessible by the user are returned.

13. The system of claim 12, wherein performing access control comprises:
accessing the ANN index, the ANN index including access control information;
determining from the ANN index whether the user has access to the candidates in the results; and
filtering out candidates that the user does not have access to.

14. The system of claim 12, wherein performing access control comprises:
calling a further service that includes access control information;
receiving the access control information from the further system; and
based on the access control information, filtering out candidates that the user does not have access to.

15. The system of claim 10, wherein performing the search comprises performing the search on a single user-centric system for a single-user query.

16. The system of claim 10, wherein performing the search comprises performing the search on a tenant-ide system for a multi-user query.

17. The system of claim 10, wherein the ANN index comprises a local ANN index that is used to retrieve the results from a local server and a global ANN index that is used to retrieve the results from a plurality of servers, the global ANN index having a same vector space as the local ANN index.

18. The system of claim 10, wherein the operations further comprise:
calculating distances between nodes of embeddings connected through implicit edges;
ranking the nodes based on respective distances; and
determining the results based on the ranking.

19. A storage medium comprising instructions which, when executed by one or more processors of a machine, cause the machine to perform operations comprising:
accessing an approximate nearest neighbor (ANN) index that indexes entities by their embeddings;
modeling a knowledge graph by including the embeddings as nodes in the knowledge graph;
receiving a search query from a device of a user;
based on the search query, performing a search of the knowledge graph to obtain results, the performing the search including traversing one or more implicit edges from a node of an embedding in the knowledge graph to one or more related nodes in semantic vector space based on the ANN index; and
causing presentation of the results on the device of the user.

20. The storage medium of claim 19, wherein the operations further comprise:
generating the embedding during execution of the search query, the embedding being valid only during the execution of the search query.
